(19) United States
(12) Patent Application Publication
(10) Pub. No.: US 2023/0398714 A1
(43) Pub. Date: Dec. 14, 2023

(54) CONTROLLED TEMPERATURE PRE-TREATMENT APPLICATION OF ADHESIVE RESIN IN ENGINEERED WOOD PRODUCTS

(71) Applicant: Smartech The Industry Pivot Ltd., Caesarea (IL)

(72) Inventors: Irina Glazer, Kfar Blum (IL); Amnon Shoshani, Givat-Ada (IL)

(73) Assignee: Smartech The Industry Pivot Ltd., Caesarea (IL)

(21) Appl. No.: 18/250,227

(22) PCT Filed: Oct. 19, 2021
(86) PCT No.: PCT/IB2021/059622

§ 371 Date: Apr. 24, 2023

Related U.S. Application Data
(60) Provisional application No. 63/105,313, filed on Oct. 25, 2020.

(51) Int. Cl. B27N 1/02; B27N 3/18; B27N 3/04; B27N 3/02

(52) U.S. Cl. CPC B27N 1/029; B27N 3/18; B27N 3/04; B27N 3/02; B27N 1/0263; B27N 1/0209

(57) ABSTRACT

A method for applying an adhesive resin in manufacturing an engineered wood product includes pre-heating an adhesive resin to a pre-application temperature before entry into an adhesive applier, maintaining the adhesive resin at the pre-application temperature for a controlled period of time to achieve improved pre-application chemical properties, and applying the adhesive resin on wood particles to form an engineered wood product.

### FIELD OF THE INVENTION

The present invention relates generally to adhesive binders in wood products, and particularly to controlled temperature pre-treatment application of adhesive resin in manufacturing engineered wood products.

### BACKGROUND OF THE INVENTION

Adhesives for bonding lignocellulosic materials are known. Lignocellulosic materials are those that contain both lignin and cellulose, which include wood and wood composite products (all referred to as engineered wood products). Conventional adhesives in the production of such lignocellulosic composite products are liquids of about 100-2500 cp (centipoise) viscosity at room temperature (about 25° C.) and roughly 40-55% resin solids content by weight. These conventional adhesives include, but are not limited to, formaldehyde polymers, such as phenol formaldehyde (PF), urea formaldehyde (UF), melamine formaldehyde (MF) or melamine urea formaldehyde (MUF), and diphenylmethane diisocyanate, commonly referred to as MDI, which has a low viscosity and is not a polymer of formaldehyde.

Conventional adhesives used in the production of oriented strand board (OSB), particleboard, fiberboard, medium density fiber board (MDF), plywood, laminated veneer lumber (LVL), cellulosic materials and other engineered wood products are applied to the substrate surface by spraying, curtain coating, roll spreading, foam extrusion, spinning disc operations, and other processes. Small amounts of adhesive must be distributed over large surface areas for efficiency. In the OSB industry PF and MDI resins are primarily used, and they enable the formation of sufficient strong and water resistant boards. In MDF and particle boards the use of UF resins is also popular.

Adhesives are usually supplied in a liquid state but some engineered wood manufacturers use adhesives in a solid state (powder).

A few engineered PF and UF resins are modified to have higher viscosities when necessary by admixing small amounts of fillers and extenders (about 2-10% by weight) or foaming agents, reaching viscosities from about 50 cp to about 15,000 cp. Higher viscosities help keep the adhesive on the panel surfaces where the adhesive properties are needed, and thus are more economical than low viscosity adhesives. If viscosity is increased too high, however, conventional adhesives application methods and apparatus cannot be used effectively.

Consequently, conventional applications for bonding wood products rely chiefly on liquid adhesives having a low viscosity because such adhesives can be effectively reduced into small droplets and applied to surfaces to be bonded. High viscosity liquid adhesives are not used because there is no accurate and reliable way to reduce them into small droplets or particles and apply them to the surfaces to be bonded.

However, conventional liquid adhesives are excessively absorbed by wood, so some of the adhesive applied to a surface is not used in bonding, and thus is in effect wasted.

Accordingly, some of the parameters that affect the quality of the adhesive to bond the wood particles include the ability of the adhesive to spread uniformly over the wood particles (better spreading means better adhesive quality), the absorption of the adhesive into the wood particles (less absorption means better adhesive quality), and the reactivity of the adhesive and its ability to create cross-linking.

However, the ability of the adhesive to spread uniformly generally tends to increase with lower viscosity, whereas the absorption of the adhesive tends to increase with lower viscosity. Thus, lower viscosity improves one parameter at the detriment of another parameter and the same of course is true for higher viscosity (less absorption but harder to spread). It would be desirable to control the viscosity to be low at spreading but immediately higher after spreading to minimize absorption.

The chemical properties (such as reactivity) of the adhesive depend on many factors which can change from one batch to another (e.g., different manufacturing parameters, such as usage of adhesive resin, its storage conditions and many more). It would be desirable to have the resin reach its optimal chemical properties, such as reactivity, exactly at the time it is used in the process.

### SUMMARY

The present invention seeks to provide an improved system and method for controlled pre-treatment application of adhesive resin in manufacturing engineered wood products, as is described more in detail hereinbelow.

In a first step, the adhesive resin is heated quickly to a high temperature which is higher than the temperature conventionally used in the prior art.

In the second step, the adhesive resin is maintained at this high temperature for a controlled period of time (which may include cooling and re-heating to achieve the desired chemical properties and/or re-heating to maintain the temperature). In one embodiment of the present invention, at the end of this second step the adhesive may be cooled and maintained in a controlled temperature until it is used, and may be reheated before use.

In a third step, the adhesive resin is used in the manufacturing process of the engineered wood product at a controlled desired temperature which may be at a high temperature or at a cooled temperature. If the adhesive resin is used after cooling, it may be re-heated to a higher temperature before use.

The heating and/or cooling may involve more than one cycle of heating or cooling and may be at different temperatures and maintained for different time durations, depending on the chemical properties of the resin prior to the treatment and the desired chemical properties of the resin after the treatment.

As a result, the viscosity of the resin is significantly higher after cooling and after its application in the process. The chemical properties, such as reactivity and/or surface tension, of the resin are much closer to the optimal chemical properties at the time of its use in the process and this improves the amount of resin that is absorbed (that is, less resin or a controlled amount of resin is absorbed) and the resin performance.

There is thus provided in accordance with an embodiment of the present invention a method for applying an adhesive resin in manufacturing an engineered wood product including pre-treatment with controlled heat of an adhesive resin to a controlled desired condition before entry into an adhesive applier, and applying the adhesive resin on wood particles to form an engineered wood product.

In accordance with an embodiment of the present invention the one or more temperature sensors and/or viscosity sensors and/or other sensors are placed in a vicinity of the heater, the adhesive applier, and the one or more temperature sensors operate in a control loop with a controller, wherein the controller is operatively coupled to the heater, the adhesive applier and the cooling unit to control heating and cooling of the adhesive resin.

### BRIEF DESCRIPTION OF THE DRAWINGS

The present invention will be understood and appreciated more fully from the following detailed description, taken in conjunction with the drawing in which:

FIG. 1 is a simplified block diagram of a system and method for controlled temperature application of adhesive resin in manufacturing engineered wood products, in accordance with a non-limiting embodiment of the present invention.

### DETAILED DESCRIPTION OF EMBODIMENTS

The term “engineered wood product” encompasses wood-containing materials, including, but not limited to, chipboard, fiber board, flake board, laminated-strand lumber, oriented strand board (OSB), medium density fiberboard (MDF), high density fiberboard (HDF), parallel-strand lumber, particle board, plywood, veneer, wafer board and others.

The term “lignocellulosic material” encompasses pieces of wood used to make engineered wood products and includes, but is not limited to, wood strands, wood particles, wood plies, wood fibers, wood chips and others.

The term “MDI” or “MDI binder” (used interchangeably) is defined as any resin prepared from methylene diphenyl di-isocyanate, such as but not limited to methylene diphenyl di-isocyanate or any kind of polymeric MDI.

The term “chemical properties” encompasses properties such as reactivity, viscosity, contact angle, molecular structure, surface tension and others.

The term “dispersion” encompasses suspension, emulsion, dispersion, solution and others.

The term “about,” as used herein, refers to variation in the numerical quantity that can occur, for example, through typical measuring and liquid handling procedures used for making concentrates or use solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about”, the claims include equivalents to the quantities.

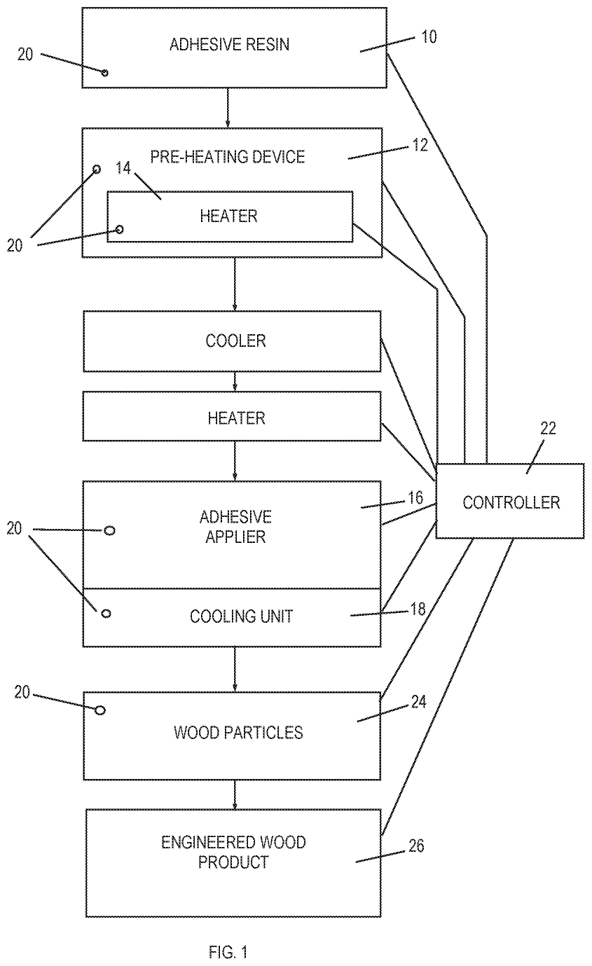

Reference is now made to FIG. 1. An adhesive resin 10, such as but not limited to, MDI or a formaldehyde polymer, such as phenol formaldehyde (PF), urea formaldehyde (UF), melamine formaldehyde (MF) or melamine urea formaldehyde (MUF), is pre-heated in a pre-heating device 12 by a heater 14. Pre-heating device 12 may be any device, such as but not limited to, a chamber, pipe system or any other device, designed to enable the controlled pre-treatment process of the invention. Pre-heating device 12 may be located at any location between the resin tanks and an adhesive applier 16 (such as near or at the entrance to or part of the adhesive applier 16.

Adhesive applier 16 may be any applying device, such as but not limited to, a spray nozzle (for spraying a stream or mist), slit nozzle or cascade nozzle for curtain coating, or a roller (for roll spreading), atomizers and others. Multiple adhesive appliers 16 may be used in the production line and different adhesives may be used at different appliers. Heater 14 may be an electric-resistance heater, a thermal oil heater, a flame from a combustible material such as a combustible gas, thermoelectric heater and others.

Heater 14 may increase the temperature of adhesive resin 10 from room temperature (e.g., 20-25° C.) or its temperature before the pre-treatment of this invention to a pre-application temperature in a range of about 40-180° C., more preferably in a range of about 50-150° C., and even more preferably in a range of about 70-120° C. Heater 14 is operated at controlled parameters (such as controlled heating time) which are determined by the chemical properties of the resin before the treatment and the desired chemical properties after the treatment.

The pre-application temperature and/or parameters are selected for the particular adhesive resin 10 so that the pre-application viscosity of adhesive resin 10 is in a range of about 1-2500 cp, more preferably in a range of about 50-2000 cp, and even more preferably in a range of about 100-1500 cp.

In contrast with the prior art, the adhesive resin is maintained at this high pre-application temperature for a controlled period of time, such as about 2-120 minutes, more preferably in a range of about 2-60 minutes, and even more preferably in a range of about 2-45 minutes. By maintaining the adhesive resin at this pre-application temperature, the adhesive resin achieves improved pre-application chemical properties (compared to chemical properties of the adhesive resin at the beginning of the controlled period of time), including but not limited to, improved pre-application viscosity (in the abovementioned ranges), improved reactivity properties and improved cross-linking ability, unattainable in the prior art.

After the adhesive resin has been maintained at this high pre-application temperature, the adhesive resin flows to the adhesive applier 16 for application of the resin to bond the lignocellulosic materials used in the particular engineering wood product process.

A cooling unit 18 may be located at an exit of adhesive applier 16. The cooling unit 18 may include, without limitation, a liquid flow convection cooler (e.g., water or oil or air as the coolant flowing in coils or tubes), a thermoelectric cooler, passive heat exchanger fins and others.

Cooling unit 18 may decrease the temperature of adhesive resin 10 to an application temperature in a range of about 10-100° C., more preferably in a range of about 20-80° C., and even more preferably in a range of about 20-60° C.

Depending on the type of adhesive applier, there may be no need for cooling unit 18.

The application temperature is selected for the particular adhesive resin 10 so that the application viscosity of adhesive resin 10 is in a range of about 300-15000 cp, more preferably in a range of about 500-10000 cp, and even more preferably in a range of about 500-7000 cp. The resin may be applied as any kind of dispersion.

Temperature sensors 20 (such as but not limited to, thermistors or thermocouples) may be placed in the vicinity of pre-heating device 12, heater 14, adhesive applier 16 and/or cooling unit 18 and operate in a control loop with a controller 22. Controller 22 is operatively coupled to heater 14, adhesive applier 16 and cooling unit 18 to control the heating and cooling of the adhesive resin 10. This provides continuous control of the process and thus there is better adhesive performance and effectiveness.

The adhesive resin 10 is applied on wood particles 24 (such as but not limited to, flakes, chips, strands, fibers, ground particles and many more) to form an engineered wood product 26.

In summary, in a first step, the adhesive resin is heated quickly to a high temperature which is higher than the temperature conventionally used in the prior art.

In the second step, the adhesive resin is maintained at this high temperature for a controlled period of time (which may include re-heating to maintain the temperature or cooling and re-heating).

In a third step, the adhesive resin is used in the manufacturing process of the engineered wood product, either at the high temperature or at a cooled temperature. If the adhesive resin is used after cooling, it may be re-heated to a higher temperature before use. The cooling or heating may involve more than one cycle of cooling or heating, depending on the chemical properties of the resin before the treatment and the desired chemical properties of the resin after the treatment.

As a result, the viscosity of the resin is significantly higher after cooling and after its application in the process. The chemical properties (such as reactivity) of the resin are much closer to the optimal chemical properties at the time of its use in the process. The surface tension of the resin is improved and this improves the amount that is absorbed.

What is claimed is:

1. A method for applying an adhesive resin in manufacturing an engineered wood product comprising:
pre-heating an adhesive resin to a pre-application temperature before entry into an adhesive applier;
maintaining said adhesive resin at said pre-application temperature for a controlled period of time; and
afterwards, applying said adhesive resin on wood particles to form an engineered wood product.

2. The method according to claim 1, wherein maintaining said adhesive resin at said pre-application temperature improves pre-application chemical properties compared to chemical properties of said adhesive resin at a beginning of said controlled period of time.

3. The method according to claim 1, wherein one or more viscosity sensors are placed in a vicinity of said heater, said adhesive applier or said cooling unit, said one or more viscosity sensors operating in a control loop with a controller, wherein said controller is operatively coupled to said heater, said adhesive applier and said cooling unit to control heating and cooling of said adhesive resin.

4. The method according to claim 1, wherein one or more temperature sensors are placed in a vicinity of said heater, said adhesive applier or said cooling unit, said one or more temperature sensors operating in a control loop with a controller, wherein said controller is operatively coupled to said heater, said adhesive applier and said cooling unit to control heating and cooling of said adhesive resin.

5. The method according to claim 1, wherein said adhesive resin comprises a formaldehyde polymer.

6. The method according to claim 1, wherein said adhesive resin comprises a resin prepared from methylene diphenyl di-isocyanate.

7. The method according to claim 1, wherein said adhesive resin comprises phenol formaldehyde (PF), urea formaldehyde (UF), melamine formaldehyde (MF) or melamine urea formaldehyde (MUF).

8. The method according to claim 1, wherein said adhesive applier comprises a spray nozzle, slit nozzle or cascade nozzle.

9. The method according to claim 1, wherein said adhesive applier comprises a roller.

10. The method according to claim 1, wherein said adhesive applier comprises an atomizer.

11. The method according to claim 1, comprising heating or cooling said adhesive resin through more than one cycle of heating or cooling.

12. An engineered wood product made by the method of claim 1.
